(19) United States
(12) Patent Application Publication
(10) Pub. No.: US 2021/0316343 A1
(43) Pub. Date: Oct. 14, 2021

(54) Fume Hood Having Structurally Integrated Components

(71) Applicant: Imperial Systems, Inc., Mercer, PA (US)

(72) Inventor: Jeremiah Wann, Mercer, PA (US)

(73) Assignee: Imperial Systems, Inc., Mercer, PA (US)

(21) Appl. No.: 17/226,742

(22) Filed: Apr. 9, 2021

Related U.S. Application Data
(60) Provisional application No. 63/007,818, filed on Apr. 9, 2020.

(51) Int. Cl. B08B 15/02

(52) U.S. Cl. CPC B08B 15/02

(57) ABSTRACT

A fume hood comprises a curved canopy supported by at least one hollow leg wherein the curved canopy is set over a workstation. The curved canopy has a plurality of adjustable fume intake ports under its apex. At least one hollow leg has a fluid connection with the fume intake ports and has an air outlet port that is configured to be connected to a negative pressure system such that fumes underneath the curved canopy are drawn into the fume intake ports, through the hollow leg, and out through the air outlet port to the negative pressure system.

### BACKGROUND

Metal cutting and welding processes such as brazing, soldering, and torch cutting produce fumes and dust particulates that are released into the surrounding air. These fumes are extremely toxic and may cause serious health issues if inhaled. The dust particulates created by welding and cutting of certain metals can contain carcinogenic particles such as nickel, cadmium, and arsenic. Prolonged exposure to metal fumes and gas byproducts can damage the nervous system and may lead to the development of lung and throat cancer. Keeping workspaces clear of these harmful fumes is crucial in maintaining a safe working environment. Fume hoods are commonly utilized by responsible employers to remove harmful fumes from the workspace to provide safe breathing zones for workers and to keep workspaces clean.

### SUMMARY

A fume hood is presented that comprises a curved canopy supported by at least one hollow leg over a workstation. The curved canopy comprises a plurality of adjustable fume intake ports under its apex and the at least one hollow leg has a fluid connection with the fume intake ports. The curved canopy is shaped to trap and direct fumes towards the fume intake ports. The hollow leg comprises an air outlet port that is configured to be connected to a negative pressure system such that fumes underneath the curved canopy are drawn into the fume intake ports, through the hollow leg, and out through the air outlet port to the negative pressure system. The fume hood may comprise a spark trap to arrest and extinguish and sparks created in the workstation. The spark trap may be a series of opposingly oriented baffles within the hollow support leg. The spark trap may also be detachable from the hollow support leg.

The fume hood may also comprise an opening in the curved canopy to allow an overhead crane to position large objects within the workstation. A welding screen may be suspended from the edges of the curved canopy to further trap fumes created in the workstation and to protect workers outside of the fume hood. The curved canopy may further comprise a chain slot to allow an overhead crane to position objects under the curved canopy. In some embodiments, the fume hood may be connected to a stand-alone negative pressure system. In other embodiments a plurality of fume hoods may be connected in series to the inlet of a central negative pressure system. In some embodiment the curved canopy may be set over a robotic welding workstation, or a human welding workstation.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF THE DRAWINGS

For a more complete understanding and appreciation of this invention, and its many advantages, reference will be made to the following detailed description taken in conjunction with the accompanying drawings.

FIG. 1 is an isometric view of a preferred embodiment of a fume hood with structurally integrated components;

FIG. 2 is an isometric view of the fume hood of FIG. 1 with the curved canopy removed and integrated spark trap removed;

FIG. 3 is a rear isometric view of the fume hood of FIG. 1

FIG. 4 is a top detail view of the fume hood of FIG. 1 with the curved canopy removed to show the adjustable fume intake ports in a partially open configuration;

FIG. 5 is a top view of the fume hood of FIG. 1 with the curved canopy removed to show the adjustable fume intake ports in a fully open configuration;

FIG. 6 is a cross section view along the line A-A from FIG. 5 portraying the flow of air through the fume hood with structurally integrated components;

FIG. 7 is a cross section view along the line B-B from FIG. 5 portraying the current created by the negative pressure system towards the fume intake ports;

FIG. 8 is a cross section view along the line C-C from FIG. 5 portraying the flow of fumes through the baffles of the integrated spark trap;

FIG. 9 is an isometric view of the fume hood of FIG. 1 having a welding curtain suspended from hanging strips along the perimeter of the curved canopy;

FIG. 10 shows the chain of an overhead crane entering the chain slot of the curved canopy;

FIG. 11 shows a fume hood situated over a robotic welding workstation;

FIG. 12 shows a fume hood situated over a human welding workstation;

FIG. 13 is an isometric view of a fume hood connected to a stand-alone negative pressure system;

FIG. 14 shows an embodiment wherein a plurality of fume hoods join a central negative pressure system; and

FIG. 15 shows an embodiment of fume hood with a single hollow leg.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

Traditional fume hoods consist of a flat hood with a central external duct for venting of fumes. These flat hoods are not optimized for air flow and must be supported at four corners by support rods that extend to the floor or hung from the ceiling with chains. In those embodiments with support rods, the four support rods take up valuable floor space and limit access throughout the plant floor.

The external ducts from prior art hoods often extend above the hood body and travel along the roof to a separate collection unit. This duct orientation takes up valuable space and can prevent overhead cranes from operating above the hood. Embodiments that are hung from the ceiling also interfere with overhead cranes. Additional external components such as spark traps and dust collectors are bulky and further reduce floor space. Optimization of the hood design and internal integration of the fume hood duct work and components can drastically reduce the required floor space per unit and increase fume removal by optimizing air flow through the system.

The addition of multiple adjustable fume intake ports increases the surface area under the hood through which fumes may be removed. A fume hood having structurally integrated components and a plurality of adjustable fume intake ports optimizes the removal of harmful fumes, removes the need for external overhead duct work and chains, and reduces the overall footprint of the system.

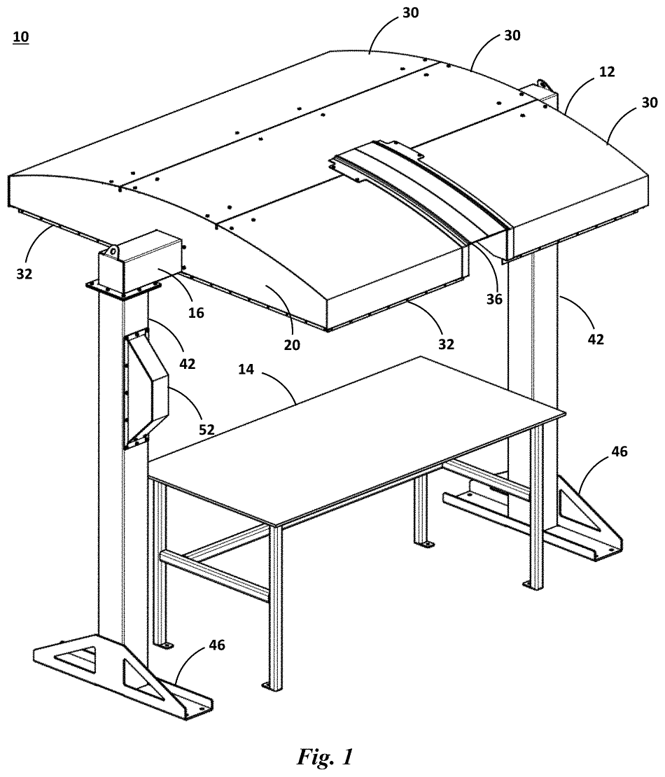

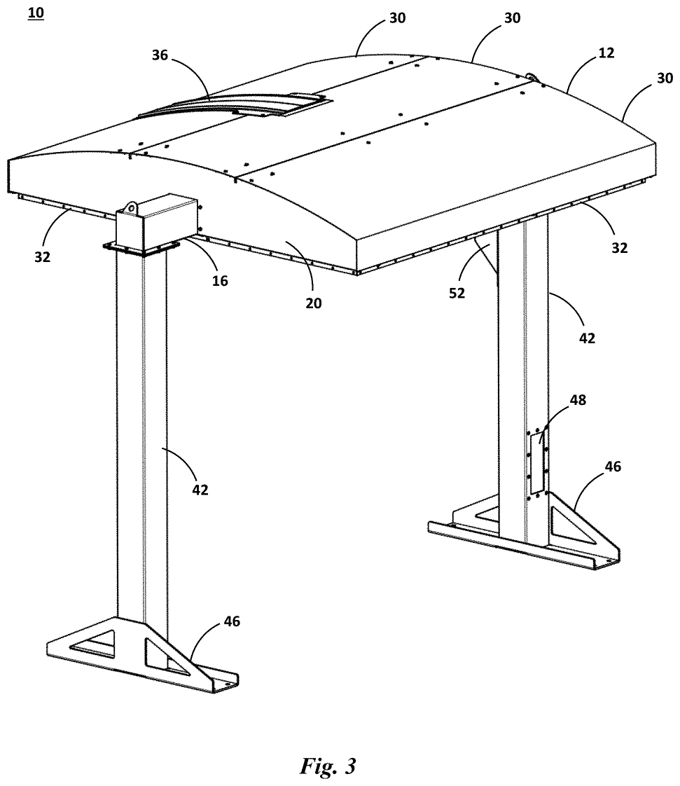

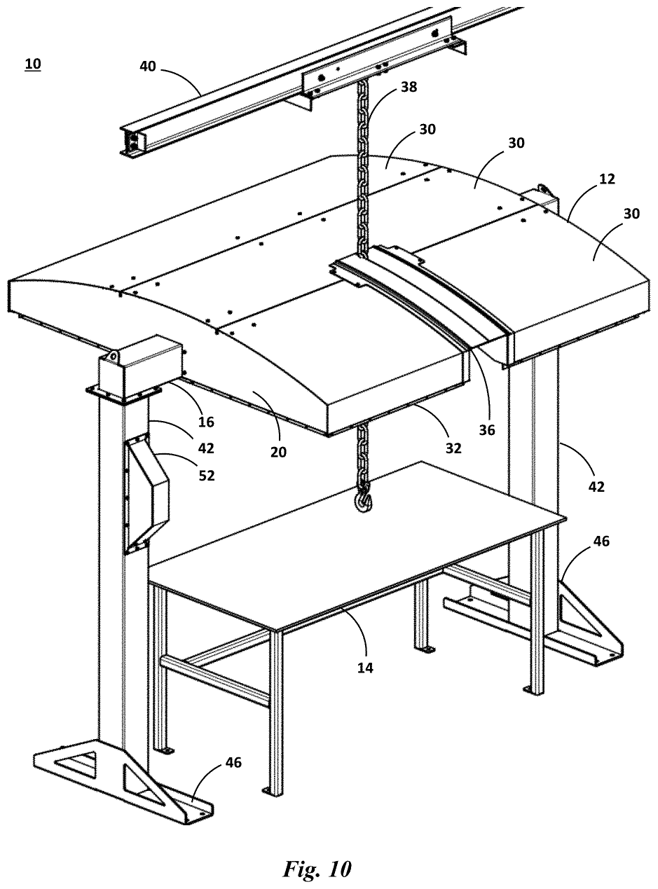

Referring now to FIGS. 1-10, the fume hood 10 is shown in its preferred embodiment. The fume hood 10 comprises a curved canopy 12 set over a workstation 14. The workstation 14 in FIG. 1 is shown to be a table to depict an area within which work that creates fumes and/or dust is performed. It is to be understood that the actual work conducted in this area can vary greatly and may not be the simple depiction of a table which is shown purely for purposes of illustration. The curved canopy 12 is shaped to promote the capture and extraction of rising fumes created at the workstation 14. A hollow support member 16 having a plurality of adjustable fume intake ports 18 extends under the length of the curved canopy 12 and supports the curved canopy 12 with rows of gussets 20. Preferably, the gussets 20 have a shape that conforms to the cross-section of the curved canopy 12 and are located at each end of the curved canopy 12 and on either side of each fume intake port 18.

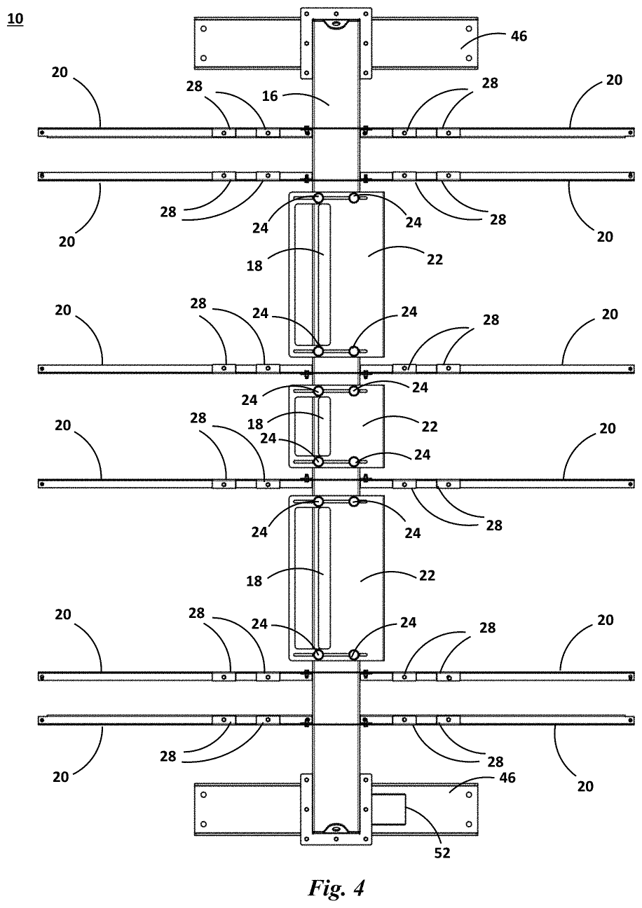

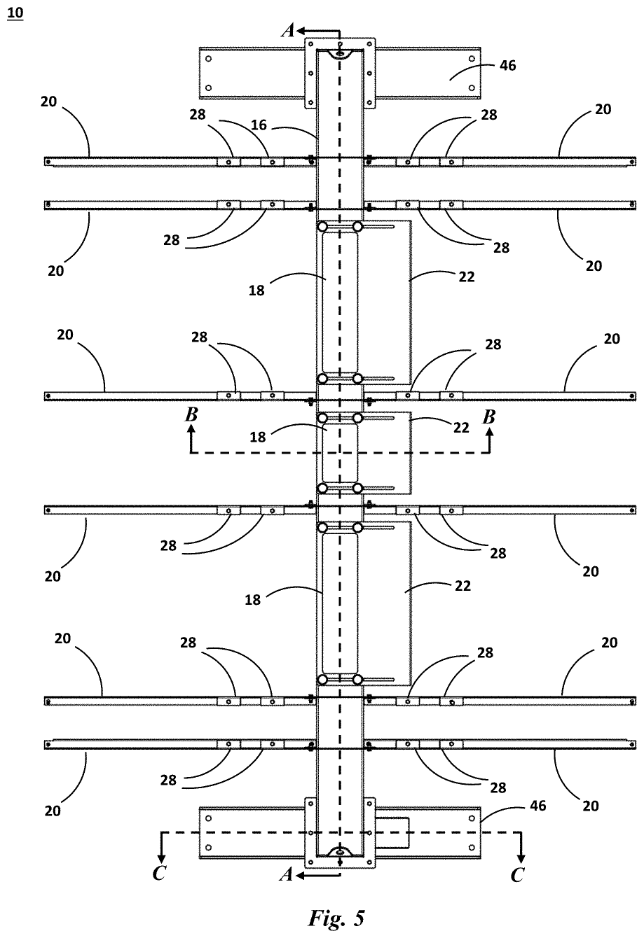

The fume intake ports 18 are positioned under the apex of the curved canopy 12 such that fumes captured underneath the curved canopy 12 are directed towards the apex to be drawn into the fume intake ports 18. A slide gate 22 is mounted over each fume intake port 18 with threaded pegs 24 to allow for quick adjustment of the slide gate over the fume intake port 18 to adjust the airflow through the fume intake port 18. The volume of airflow may be determined by many factors including the size of the curved canopy 12 and number of fume intake ports 18. In the preferred embodiment the slide gates 22 are actuated perpendicularly to the hollow support member 16 as shown in FIGS. 4-5. However, certain embodiments of the fume hood 10 may require that the slide gates 22 actuate in a direction parallel to the hollow support member 16. The slide gates 22 shown in the figures are manually actuated but they may be actuated mechanically, pneumatically, or by other means.

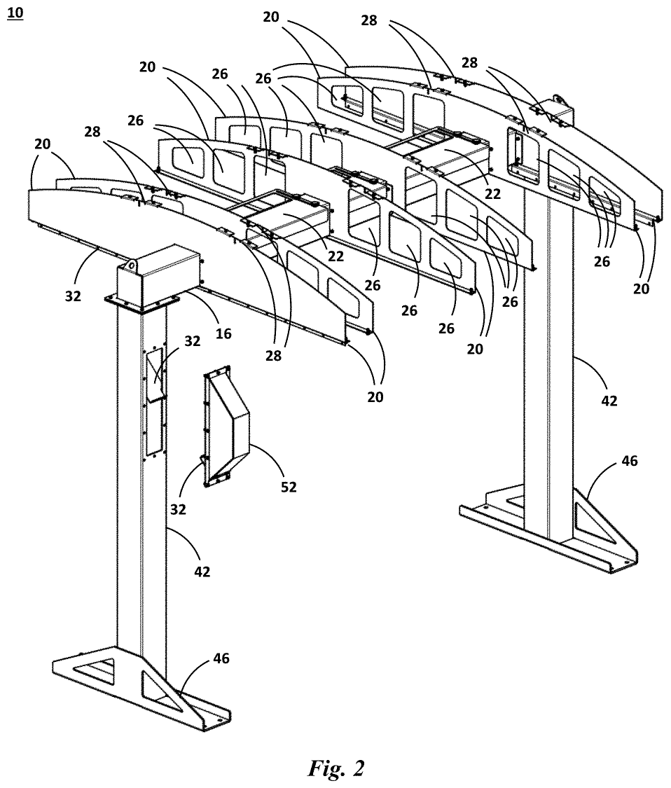

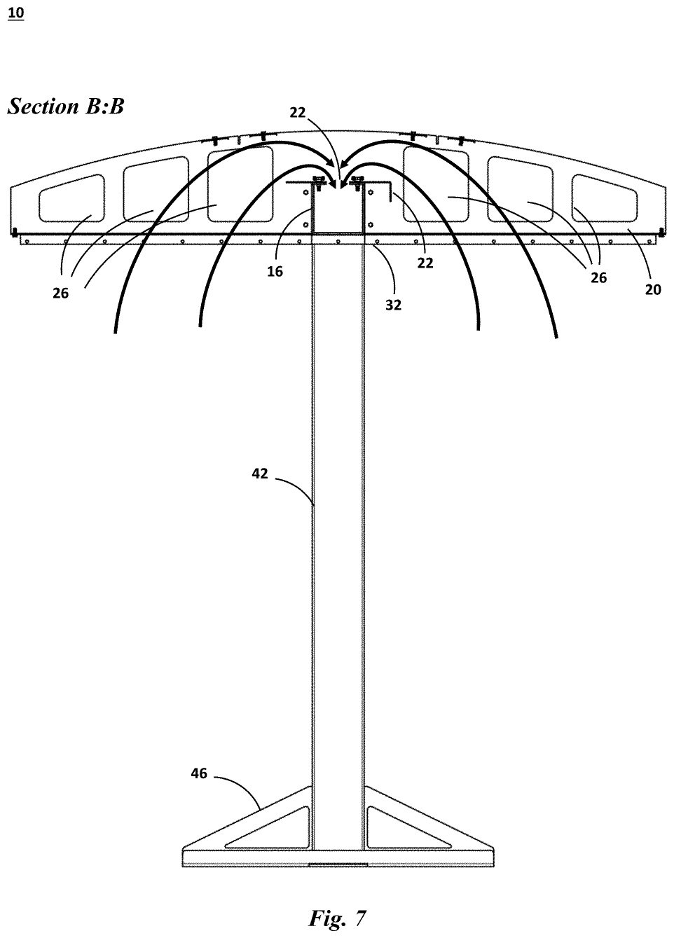

As best shown in FIGS. 2 and 7, in the preferred embodiment, the gussets 20 located on either side of the fume intake ports 18 comprise a plurality of openings 26 to improve airflow under the curved canopy 12 and also reduce the weight of the gussets. The gussets 20 at the ends of the curved canopy 12 do not have any opening as they form the side perimeter of the canopy 12 to create a fully closed canopy 12 for containment of rising fumes. Each gusset 20 comprises a number of mounting brackets 28 configured to receive bolts through the curved canopy 12 to secure the canopy 12 over the hollow support member 16.

Preferably, the curved canopy 12 is comprised of a plurality of smaller curved segments 30 that span across each row of gussets 20 to form a section of the canopy 12. Smaller segments 30 configured in this manner enable easy of construction and create a more modular assembly. The position and size of each fume intake port 18, gusset 20, and curved segment 30 may be determined by system requirements and the overall size of the canopy 12.

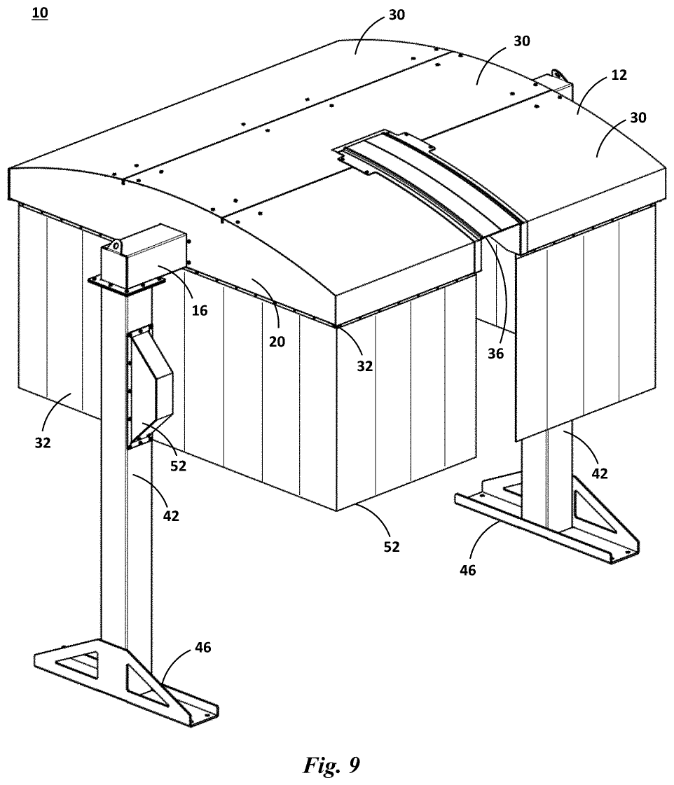

Along the bottom perimeter of the curved canopy 12 may be hanging strips 32 for suspending a weld curtain or strip flaps 34 as shown in FIG. 9. Such curtains add an extra layer of protection for workers inside and outside of the workstation 14 by further containing fumes, dust, sparks, noise, and the light produced by welding instruments. The curved canopy 12 may also include a chain slot 36 which allows the chain 38 from an overhead crane 40 to pass into the curved canopy 12 to position objects that may be large and unwieldy within the workstation 14 and to remove objects from the workstation 14. This chain slot 36 may be covered by brush strips, flaps, or a removeable cap for ease of access. The chain slot 36 may also comprise a mechanically actuated door that may be closed to keep the curved canopy 12 sealed when the chain slot 36 is not in use.

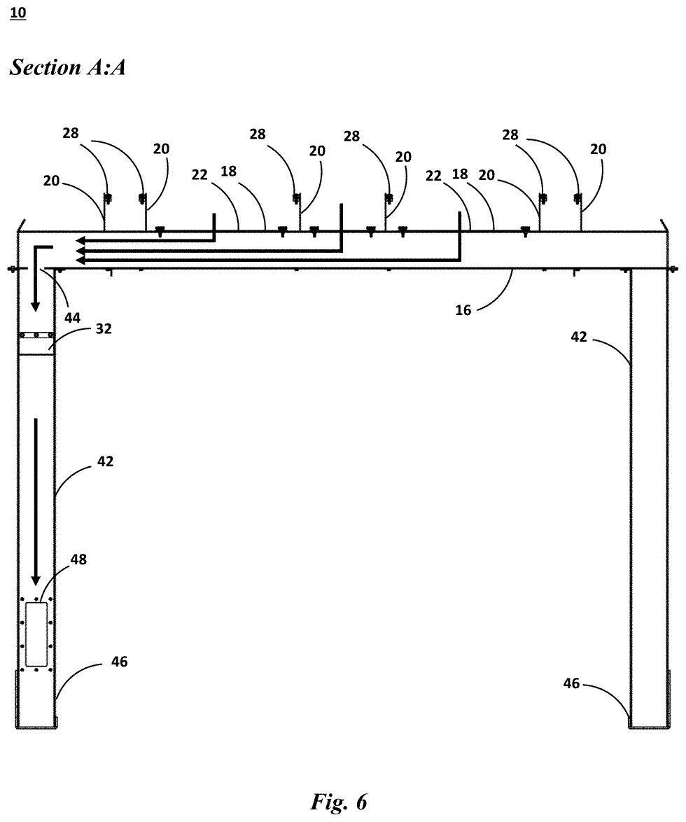

The top end of the hollow legs 42 connect to the hollow support member 16 to set the curved canopy 12 over the workspace 14. A baseplate 46 is connected to the bottom end of the hollow leg 42 and is anchored to the ground with bolts such that the curved canopy 12 is held parallel to the ground. A fluid passage 44 exists at the connection between the top end of the hollow leg 42 and the hollow support member 16 enabling fumes entering the intake ports 18 to flow into the hollow leg 42. Towards the bottom end of the hollow leg 42 there may be an air outlet port 48 that is configured to be connected to a negative pressure system 50 such as a fume extractor or dust collector. As shown in FIG. 6, the negative pressure system 50 is in fluid connection with the fume intake ports 18 via the hollow leg 42 and provides enough suction such that fumes underneath the curved canopy 12 are drawn into the fume intake ports 18, through the hollow leg 42, and out through the air outlet port 48 to the negative pressure system 50. The negative pressure system 50 may also provide enough suction through the fume intake ports 18 to create a slight upward draft underneath the curved canopy 12 that pulls fumes created at the workstation 14 upwards along the curved canopy 12 and into the fume intake ports 18 as portrayed in FIG. 7. However, only one hollow leg 42 need be in fluid connection with the fume intake ports 18 and the negative pressure system 50 as portrayed in FIG. 6. Larger systems that demand an increased volume of air flow may have both hollow legs 42 in fluid connection with the fume intake ports 18 and the negative pressure system 50 for effective fume removal over a larger area.

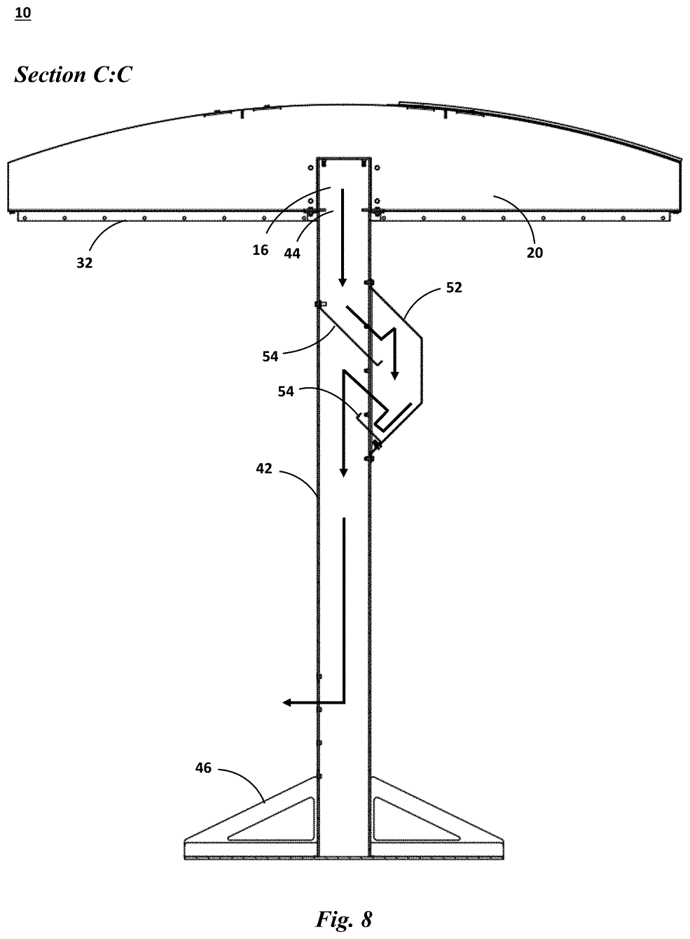

A spark trap 52 may be integrated within the hollow leg 42 to arrest any sparks that have been created at the workstation. The spark trap 52 shown as shown in FIGS. 1, 2, 6, and 8 comprises a series of opposingly oriented baffles 54. The spark trap 52 may be integrated at any point on the hollow leg 42 between its top end and the air outlet port 48 to prevent any sparks from entering the negative pressure system 50. As shown in FIG. 8, each baffle 54 may include an angled protrusion at their downstream end that impedes and redirects the flow of fumes to effectively trap and extinguish any sparks created at the workstation 14 that may have entered the fume hood 10 through the fume intake ports 18. The spark trap 52 may be mounted with bolts or screws such that it may be easily removed from the hollow leg 42 for cleaning.

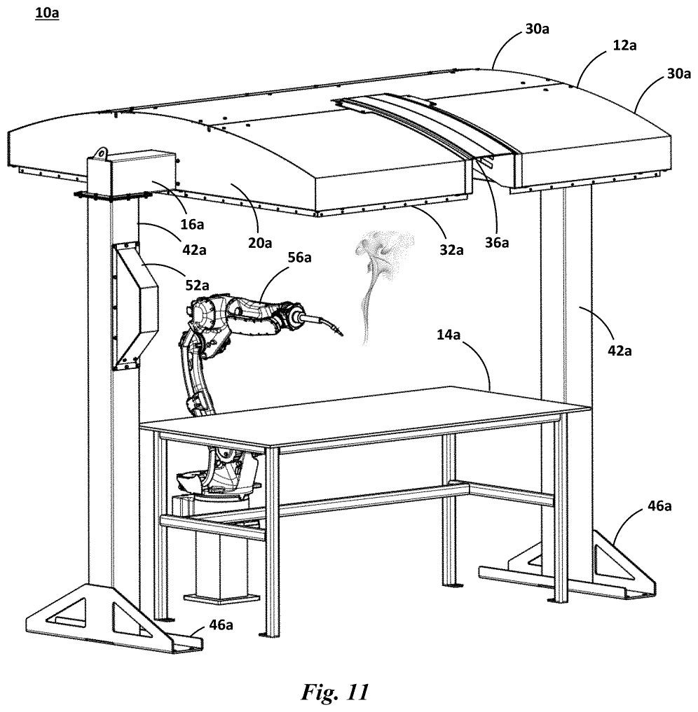

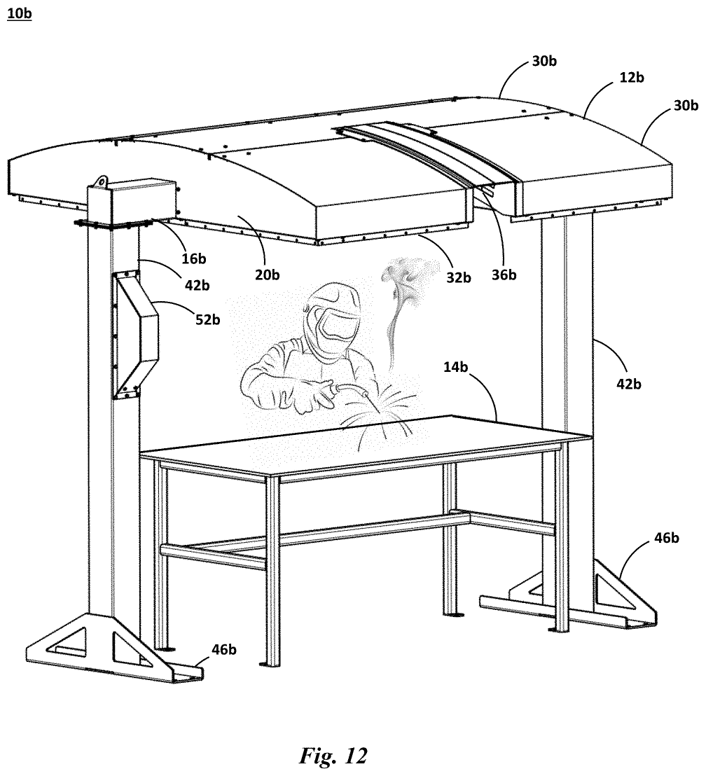

FIG. 11 shows an embodiment of the fume hood 10a having workstation 14a configured for a robotic welding arm 56a. FIG. 12 shows an embodiment of the fume hood 10b having workstation 14b configured for human welding and cutting. Other embodiments may be configured for a plasma torch cutting table or any other machine or operation that creates undesirable fumes and dust.

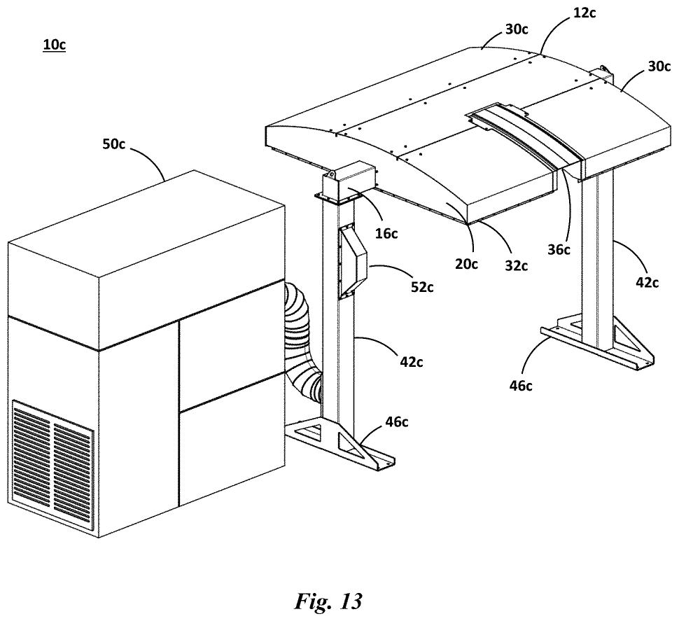

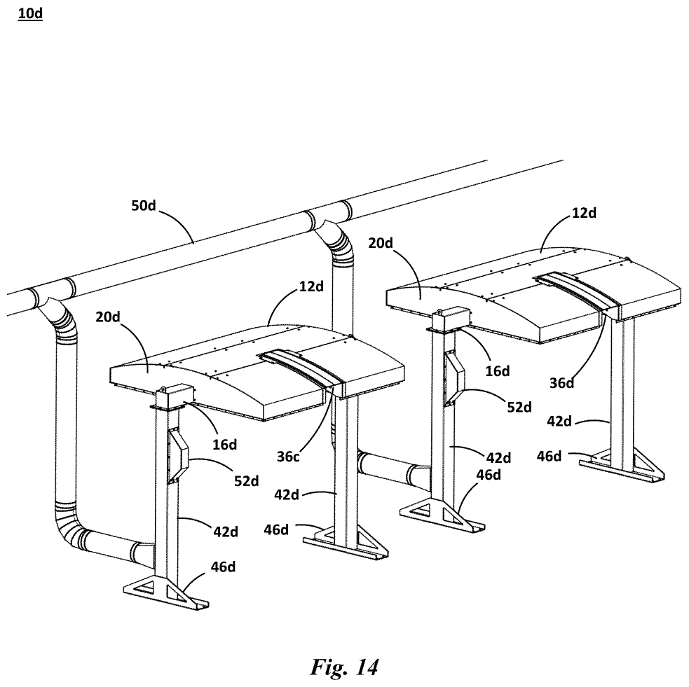

The embodiment of the fume hood 10c shown in FIG. 13, is connected to a stand-alone negative pressure system 50c, while FIG. 14 shows an embodiment wherein a plurality of fume hoods 10d join a central pressure system 50d that may remove air fumes from underneath each curved canopy 12d.

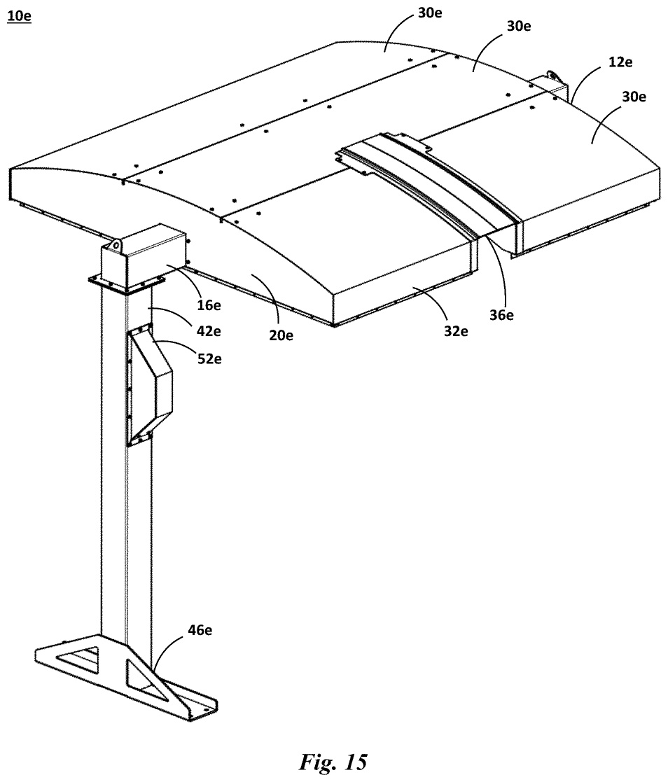

FIG. 15 shows an embodiment of fume hood 10e which has only one hollow leg 42e. This embodiment allows for more floor space but is limited in the size of the curved canopy 12e that can be supported by a single hollow leg 42e.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A fume hood comprising;
a curved canopy supported by at least one hollow leg wherein said curved canopy is set over a workstation;
said curved canopy having a plurality of adjustable fume intake ports under its apex; and
said at least one hollow leg having a fluid connection with said fume intake ports and having an air outlet port that is configured to be connected to a negative pressure system such that fumes underneath said curved canopy are drawn into said fume intake ports, through said hollow leg, and out through said air outlet port to the negative pressure system.

3. The fume hood of claim 1 further comprising said curved canopy is shaped to trap and direct fumes towards said fume intake ports.

4. The fume hood of claim 1 further comprising a spark trap detachably mounted within said hollow support leg.

5. The fume hood of claim 1 further comprising a spark trap that comprises a series of opposingly oriented baffles mounted within said hollow support leg.

6. The fume hood of claim 1 further comprising an opening in said curved canopy to allow an overhead crane to position objects under said curved canopy.

7. The fume hood of claim 1 further comprising a welding screen suspended from the edges of said curved canopy.

8. The fume hood of claim 1 further comprising an opening in said curved canopy to allow suspended objects to a crane to position large objects within said workstation.

9. The fume hood of claim 1 further comprising the negative pressure system is one of a stand-alone extraction unit and a central unit that may extract fumes from a plurality of fume hoods.

10. The fume hood of claim 1 further comprising said workstation is one of a welding station and robotic welding station.
